(19) United States
(12) Patent Application Publication
(10) Pub. No.: US 2019/0018272 A1
(43) Pub. Date: Jan. 17, 2019

(54) DISPLAY PANEL AND DISPLAY DEVICE

(71) Applicant: BOE TECHNOLOGY GROUP CO., LTD., Beijing (CN)

(72) Inventors: Weili ZHAO, Beijing (CN); Xue DONG, Beijing (CN); Jikai YAO, Beijing (CN)

(73) Assignee: BOE TECHNOLOGY GROUP CO., LTD., Beijing (CN)

(21) Appl. No.: 15/577,121

(22) PCT Filed: Feb. 13, 2017
(86) PCT No.: PCT/CN17/73383

§ 371 Date: Nov. 27, 2017

(30) Foreign Application Priority Data
Jun. 1, 2016 (CN) 201610382230.8

(51) Int. Cl. G02F 1/13363; G02F 1/1335; G02B 5/30

(52) U.S. Cl. CPC G02F 1/13363; G02F 1/133528; G02F 2202/40; G02F 2001/133565; G02B 5/3025

(57) ABSTRACT

The present disclosure provides a display panel and a display device, relating to the filed of display technology, at least partly solving the problem of light leakage in the existing display panel and reducing the amount of light leakage. The display panel of the present disclosure includes an array substrate, an opposite substrate and a liquid crystal layer between the array substrate and the opposite substrate; an optical compensation film disposed at either side of the liquid crystal layer, wherein the optical compensation film is configured to compensate for a phase retardation subjected by light passing through the liquid crystal layer.

### CROSS-REFERENCE OF RELATED APPLICATION

The present application is based on International Application No. PCT/CN2017/073383, filed on Feb. 13, 2017, which claims the benefits of Chinese patent application No. 201610382230.8 titled “DISPLAY PANEL AND DISPLAY DEVICE”, which was filed with the SIPO on Jun. 1, 2016 and are fully incorporated herein by reference as part of this application.

### TECHNICAL FIELD

The present disclosure relates to the field of display technology, and particularly to a display panel and a display device.

### BACKGROUND

Liquid crystal display (LCD) panel has been widely used in various types of electronic information devices such as television, computer, mobile phone, personal digital assistant and the like.

Currently, the LCD has a structure as illustrated in FIG. 1, including an array substrate 1, an opposite substrate 3, and a liquid crystal layer 2 located between the array substrate 1 and the opposite substrate 3. The LCD further includes a lower polarizer 5 located at an external side of the array substrate 1 and an upper polarizer 6 located at an external side of the opposite substrate 3. The LCD may be mainly classified into vertical alignment LCD (VA-LCD) and in-plane switching LCD (IPS-LCD). Liquid crystals in VA-LCD are vertically arranged to provide relatively higher contrast ratio and would not cause any light leakage under a dark state; however, the VA-LCD is narrow in viewing angle, and the liquid crystal layer may cause phase retardation to the light passing there-through under a slant angle, resulting in light leakage. The liquid crystals in the IPS-LCD are horizontally arranged to provide poor contrast ratio but relatively broader viewing angle; however, during a assembling process of IPS-LCD, a peripheral region thereof is fixed mechanically, which may result in bending distortion due to uneven force as subjected. In case of bending distortion, light leakage may occur at stress concentration regions.

The reason why light leakage may occur at stress concentration regions is that a glass substrate applied with no stress effect is an isotropic medium which would not cause birefringence phenomenon; when a distortion is generated under the stress effect, a refractivity of the glass substrate will be changed to produce a birefringence phenomenon, and at this moment, light leakage may occur if an optical axis of the glass substrate is neither parallel to nor perpendicular with a polarization direction of the polarizer.

Therefore, how to design a display panel and a display device with little or no light leakage has become one of urgent problems to be solved, by far.

### SUMMARY

In order to at least partly solve the problem above, the present disclosure provides a display panel and a display device. The display panel and the display device considerably reduce an amount of light leakage as compared to existing display panels and display devices.

The technical solutions as adopted to solve the technical problem of the present disclosure may include: providing a display panel including an array substrate, an opposite substrate and a liquid crystal layer between the array substrate and the opposite substrate. An optical compensation film is further disposed at either side of the liquid crystal layer, and the optical compensation film is configured to compensate for a phase retardation subjected by light passing through the liquid crystal layer.

In an example of the embodiment, a phase retardation caused by the optical compensation film to the light is equal to a phase retardation caused by liquid crystals in the liquid crystal layer to the light.

In an example of the embodiment, the optical compensation film is a first optical compensation film satisfying an optical conditional expression of nₓ>n_{y}=n_{z}, wherein nₓ indicates a refractivity in a X-axis direction of a surface of the optical compensation film, n_{y} indicates a refractivity in a Y-axis direction of the surface of the optical compensation film, and n_{z} indicates a refractivity in a Z-axis direction along a thickness of the optical compensation film; and wherein a direction of optical axis of the first optical compensation film is perpendicular to a long axis of a liquid crystal in the liquid crystal layer.

In an example of the embodiment, the optical compensation film is a second optical compensation film satisfying an optical conditional expression of nₓ<n_{y}=n_{z}, wherein nₓ indicates a refractivity in a X-axis direction of a surface of the optical compensation film, n_{y} indicates a refractivity in a Y-axis direction of the surface of the optical compensation film, and n_{z} indicates a refractivity in a Z-axis direction along a thickness of the optical compensation film; and wherein a direction of optical axis of the second optical compensation film is parallel to a long axis of a liquid crystal in the liquid crystal layer.

In an example of the embodiment, the optical compensation film further satisfies optical conditional expressions of 1.4≤nₓ≤2.0, 1.4≤n_{y}≤2.0, 1.4≤n_{z}≤2.0, and a result of (nₓ−n_{y})*d equals to the phase retardation caused by the liquids crystals in the liquid crystal layer to the light, wherein d is a thickness of the optical compensation film.

In an example of the embodiment, the display panel further includes a first protection layer and a second protection layer which are located at two sides of the optical compensation film, respectively.

In an example of the embodiment, the optical compensation film is located at a side of the opposite substrate adjacent to the liquid crystal layer, or is located at a side of the array substrate adjacent to the liquid crystal layer.

In an example of the embodiment, a phase retardation of the light caused by the opposite substrate is equal to a phase retardation of the light caused by the array substrate; and a direction of optical axis of the opposite substrate is orthogonal to a direction of optical axis of the array substrate.

In an example of the embodiment, a material of the optical compensation film includes cellulose triacetate.

Another technical solution provided by the present disclosure lies in: a display device including the aforementioned display panel.

The display panel and the display device in certain embodiments of the present disclosure achieve an effect of compensating for a phase retardation of light passing through the array substrate, the liquid crystal layer and the opposite substrate, by utilizing an optical compensation film disposed at either side of the liquid crystal layer, so as to offset an overall phase retardation of the light, considerably reduce an amount of light leakage, increase a contrast ratio of the display panel and display device, and improve a display quality of images.

### BRIEF DESCRIPTION OF THE DRAWINGS

FIG. 1 is a structural schematic view of an existing LCD panel;

FIG. 2 is a structural schematic view of a LCD panel in a first embodiment of the present disclosure;

FIG. 3 is a schematic view illustrating a principle of light leakage in the existing LCD panel;

FIG. 4 is a schematic view illustrating a simulated light leakage in the existing LCD panel;

FIG. 5 is a schematic view illustrating a principle of light leakage in the LCD panel of FIG. 2;

FIG. 6A is a diagram illustrating a light leakage status of the display panel in FIG. 2, and FIG. 6B is a diagram illustrating a light leakage status of the existing display panel;

FIG. 7A is a diagram illustrating a VT curve of a IPS display panel in the first embodiment, and FIG. 7B is a diagram illustrating a VT curve of an existing IPS display panel; and

FIG. 8 is a structural schematic view of a LCD panel in a second embodiment of the present disclosure.

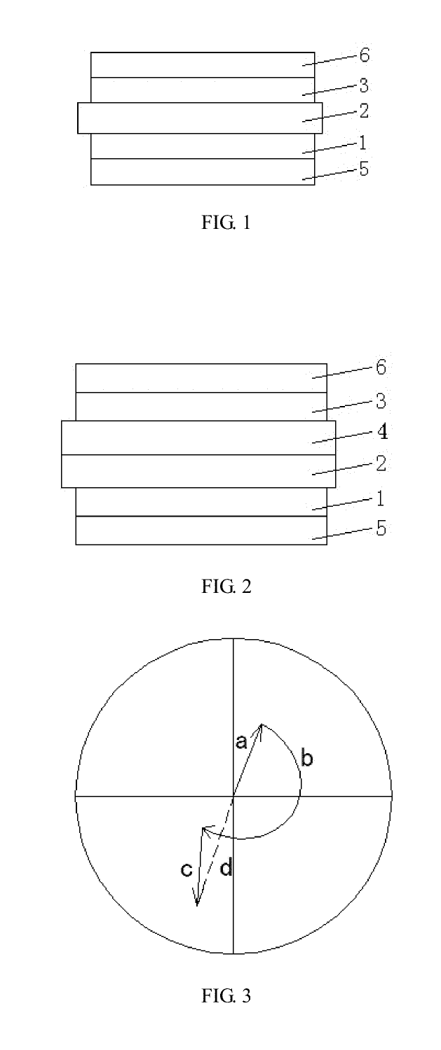

### REFERENCE NUMERALS

1—array substrate; 2—liquid crystal layer; 3—opposite substrate; 4—optical compensation film; 5—lower polarizer; 6—upper polarizer.

### DETAILED DESCRIPTION

Hereinafter, the present disclosure will be described specifically in conjunction with drawings and particular embodiments so that those skilled in the art would well understand the technical solutions of the present disclosure.

### The First Embodiment

The present embodiment provides a display panel, in which a side of an opposite substrate adjacent to a liquid crystal layer is provided with an optical compensation film. The optical compensation film is configured to compensate for a phase retardation subjected by light passing through the liquid crystal layer.

FIG. 2 is a structural schematic view of a liquid crystal display (LCD) panel in the present embodiment. As illustrated in FIG. 2, the display panel includes an array substrate 1, an opposite substrate 3, and a liquid crystal layer 2 located between the array substrate 1 and the opposite substrate 3; a side of the opposite substrate 3 adjacent to the liquid crystal layer 2 is provided with an optical compensation film 4. The display panel further includes a lower polarizer 5 located at an external side of the array substrate 1, and an upper polarizer 6 located at an external side of the opposite substrate 3.

In the present embodiment, a material of the optical compensation film 4 includes cellulose triacetate (TAC), which causes a phase retardation to the light equally to a phase retardation caused by liquid crystals in the liquid crystal layer 2 to the light. In this way, the optical compensation film 4 enables offsetting the phase retardation subjected by light when passing through the liquid crystal layer 2, and thereby preventing light leakage from occurring in the display panel under stress effect.

The optical compensation film 4 may adopt a first optical compensation film having a direction of optical axis perpendicular (orthogonal) to a long axis of a liquid crystal in the liquid crystal layer 2. In the related art, the first optical compensation film may also be referred to as a “+a-plate” which satisfies an optical conditional expression of nₓ>n_{y}=n_{z}, wherein nₓ indicates a refractivity in a X-axis direction of a surface of the optical compensation film, n_{y} indicates a refractivity in a Y-axis direction of a surface of the optical compensation film, and n_{z} indicates a refractivity in a Z-axis direction along a thickness of the optical compensation film; and wherein 1.4≤nₓ≤2.0, 1.4≤n_{y}≤2.0, 1.4≤n_{z}≤2.0. An in-plane phase retardation caused by the first optical compensation film is expressed by Rₒ=(nₓ−n_{y})*d, wherein d is a thickness of the first optical compensation film, a value of Rₒ is equal to a phase retardation caused by liquid crystals in the liquid crystal layer 2 to the light and is usually ranged from 280 nm to 400 nm.

In a similar way, the optical compensation film 4 may adopt a second optical compensation film having a direction of optical axis parallel to the long axis of the liquid crystal in the liquid crystal layer. In the related art, the second optical compensation film may also be referred to as a “−a-plate” which satisfies an optical conditional expression of nₓ<n_{y}=n_{z}, wherein nₓ indicates a refractivity in a X-axis direction of a surface of the optical compensation film, n_{y} indicates a refractivity in a Y-axis direction of a surface of the optical compensation film, and n_{z} indicates a refractivity in a Z-axis direction along a thickness of the optical compensation film; and wherein 1.4≤nₓ≤2.0, 1.4≤n_{y}≤2.0, 1.4≤n_{z}≤2.0. An in-plane phase retardation caused by the second optical compensation film is expressed by Rₒ=(nₓ−n_{y})*d, wherein d is a thickness of the second optical compensation film, a value of Rₒ is equal to a phase retardation caused by liquid crystals in the liquid crystal layer 2 to the light and is usually ranged from 280 nm to 400 nm.

The display panel, when curved, may produce a stress effect. As both of the array substrate 1 and the opposite substrate 3 include a glass base, a corresponding retardation may be generated in the light during the light passing through the array substrate 1 and the opposite substrate 3, which in turn leads to light leakage. The phase retardation caused by the glass base to the light may be calculated according to a formula as below:

Rₒ=C*t*s (1)

In the formula, Rₒ indicates a phase retardation caused by the glass base to the light, C indicates a photoelastic coefficient of the glass base, t indicates a thickness of the glass base, and s indicates a stress force subjected by the glass base.

In the formula, the stress force subjected by the glass base may be calculated according to a formula as below:

s=E*t/(2R) (2)

In the formula, E indicates a young's modulus, t indicates a thickness of the glass base, R indicates a radius of curvature. In the formula, a value of R may be configured according to particular products and is usually ranged from 1000 nm to 8000 nm.

Based on the formula (1) and the formula (2), the optical retardation caused by the glass base in the array substrate 1 and the in opposite substrate 3, respectively, may be obtained.

In the display panel of the present embodiment, taking the lower polarizer 5 as a reference, given that an angle of a transmittance axis of the lower polarizer 5 is zero and causes a phase retardation of 0 nm to the light, then parameters such as an angle of each of other structures in various layers with respect to the transmittance axis of the lower polarizer 5 and a phase retardation caused by the respective structure may be as below.

The array substrate 1 has a direction of optical axis which is 120° and causes a phase retardation which is 9 nm.

The liquid crystal layer 2 has a direction of optical axis which is 0° and causes a phase retardation which is 350 nm.

The optical compensation film 4 has a direction of optical axis which is 0/90° and causes a phase retardation which is 350 nm.

The opposite substrate 3 has a direction of optical axis which is 30° and causes a phase retardation which is 9 nm.

The upper polarizer 6 has a direction of optical axis which is 90° and causes a phase retardation which is 0 nm.

Therefore, in the display panel of the present embodiment, the phase retardation caused by the opposite substrate 3 to the light is equal to the phase retardation caused by the array substrate 1 to the light, and the direction of optical axis of the opposite substrate 3 is orthogonal to the direction of optical axis of the array substrate 1. As a result, the direction of optical axis and the phase retardation of the array substrate 1 are cancelled out by the direction of optical axis and the phase retardation of the opposite substrate 3 and of the upper polarizer 6; while the direction of optical axis and the phase retardation of the liquid crystal layer 2 are cancelled out by the direction of optical axis and the phase retardation of the optical compensation film 4. In this way, the phase retardations caused by structures in upper layers and the phase retardations caused by structures in lower layers are cancelled out by each other, thereby achieving the effect of reducing or eliminating light leakage.

The existing display panel may suffer from light leakage when distorted under force. For more details, as illustrated by a poincare sphere in FIG. 3, the light may be subjected to a first phase retardation (as indicated by a straight line arrow “a” pointed upwards in FIG. 3) when passing through the array substrate 1, and subjected to a second phase retardation (as indicated by a clockwise arc-arrow “b” in FIG. 3) when passing through the liquid crystal layer 2, and then subjected to a third phase retardation (as indicated by a straight line arrow “c” pointed downwards in FIG. 3). A line connecting a start point of the straight line arrow “a” pointed upwards and an end point of the straight line arrow “c” pointed downwards indicates an amount of light leakage (as indicated by a dashed line segment “d” in FIG. 3) in the LCD panel.

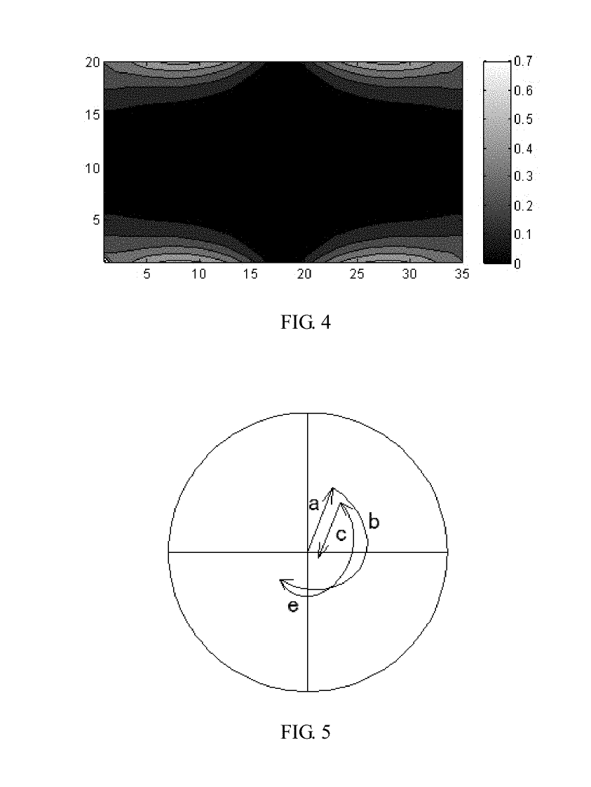

In addition, FIG. 4 is a schematic diagram illustrating a simulated light leakage in the existing LCD panel, in which a horizontal axis indicates a long side of the LCD panel, a longitudinal axis indicates a short side of the LCD panel, and vertically arranged bar-like icons indicate light leakage amount corresponding to different colors of the LCD panel. The amount of light leakage as simulated at each of four corners of the LCD panel is 0.7%, that is to say, in the case where a brightness value under an illumination state is 400 nit, the amount of light leakage at each of the four corners of the LCD panel will be up to 400*0.7%=2.8 nit.

However, considering the liquid crystal layer 2 and the optical compensation film 4 in the display panel of the present embodiment as a whole, the phase retardation thereof Rₒ=(nₓ−n_{y})*d (in the formula, d indicates the whole thickness), may be reduced to zero. At the same time, the phase retardation caused by the array substrate 1 to the light and the phase retardation caused by the opposite substrate 3 to the light are equal to each other, and hence cancelled out by each other, so as to reduce or eliminate the light leakage. As illustrated by the poincare sphere in FIG. 5, the light may be subjected to a first phase retardation (as indicated by a straight line arrow “a” pointed upwards in FIG. 5) when passing through the array substrate 1, and subjected to a second phase retardation (as indicated by a clockwise arc-arrow “b” in FIG. 5) when passing through the liquid crystal layer 2, then subjected to a third phase retardation (as indicated by an anticlockwise arc-arrow “e” in FIG. 5) when passing through the optical compensation film 4, and finally subjected to a fourth phase retardation (as indicated by a straight line arrow “c” pointed downwards in FIG. 5) when passing through the opposite substrate 3. In this way, a line connecting a start point of the straight line arrow “a” pointed upwards and an end point of the straight line arrow “c” pointed downwards indicates an amount of light leakage in the LCD panel. In this case, as illustrated in FIG. 5, since the start point and the end point both are located at an original point, the amount of light leakage in the display panel of the present embodiment is nearly zero (in FIG. 5, in order to distinguish the straight line arrow “a” pointed upwards representative of the first phase retardation from the straight line arrow “c” pointed downwards representative of the fourth phase retardation, the two straight line arrows that actually coincide with each other are illustrated to be deviated from each other).

In addition, the display panel of the present embodiment further includes a first protection layer and a second protection layer which are located at two sides of the optical compensation film 4, respectively, and configured to effectively protect the optical compensation film 4.

The optical compensation film 4 in the display panel may be prepared by steps as below.

First of all, forming a first protection layer at an inner side of the opposite substrate 3.

Subsequently, forming and solidifying an optical compensation film 4 on the first protection layer.

Then, forming a second protection layer on the optical compensation film 4.

Finally, preparing other structures in respective layers according to normal processes.

During the preparation, since the optical compensation film 4 inherently possesses property of high-temperature resistance, no other negative effects due to process technology would be caused.

FIG. 6A and FIG. 6B are diagrams illustrating a light leakage condition of the display panel in the present embodiment and a light leakage condition of the existing display panel, respectively. As illustrated, FIG. 6A, is a diagram of simulated light leakage in the existing display panel and FIG. 6B is a diagram of simulated light leakage of the display panel in the present embodiment. As it can be seen, a relative value of light leakage of the existing display panel under dark state is approximately 1%, while a relative value of light leakage of the display panel in the present embodiment under dark state is nearly 0%. In other words, the display panel in the present embodiment barely involves light leakage under dark state.

The display panel in the present embodiment can not only be designed as a vertical alignment (VA) display panel but also can be designed as an in-plane switching (IPS) display panel. In the IPS display panel, the direction of optical axis and the phase retardation of the liquid crystal layer are respectively cancelled out by the direction of optical axis and the phase retardation of the optical compensation film 4. In this way, the phase retardation caused by structures in upper layers and the phase retardation caused by structures in lower layers are cancelled out by each other to achieve the effect of reducing or eliminating light leakage.

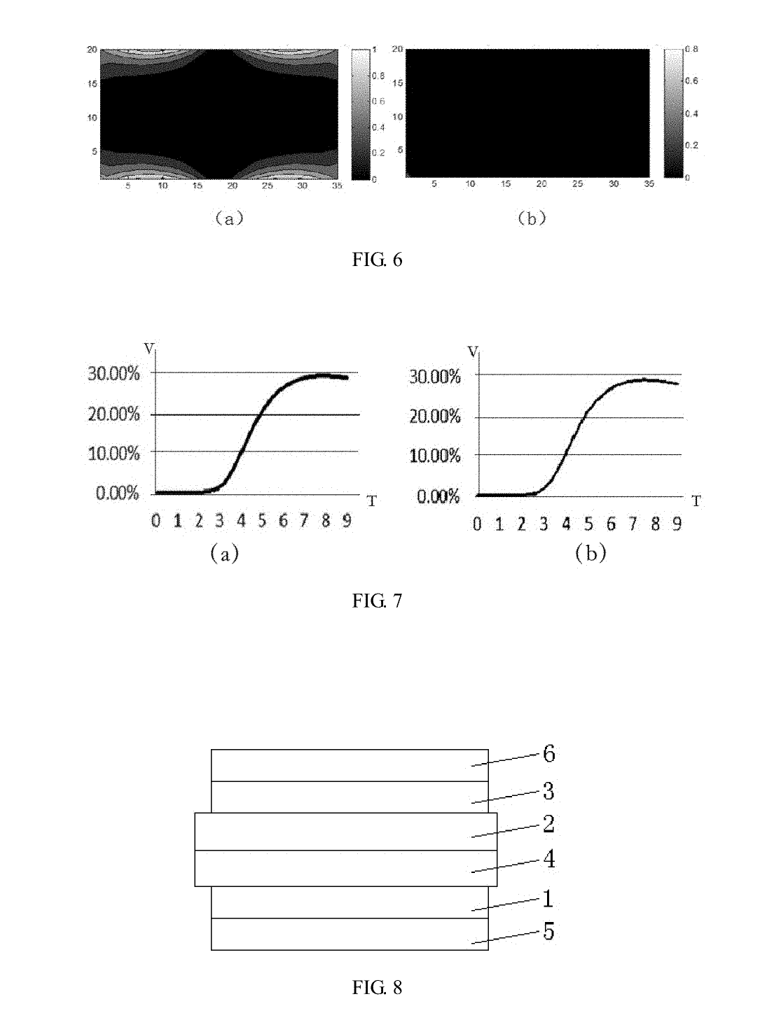

FIG. 7A and FIG. 7B are diagrams illustrating a VT curve of an IPS display panel in the present embodiment and a VT curve of an existing IPS display panel, respectively. As illustrated, FIG. 7A is a VT curve of the existing IPS display panel while FIG. 7B is a VT curve of the IPS display panel in the present embodiment, in which a longitudinal axis T indicates a transmittance and a horizontal axis indicates a magnitude of voltage. As it can be seen, in the case where the structures of various layers in the existing IPS panel are provided with identical optical parameters with that in the IPS display panel of the present embodiment, the existing IPS display panel has a transmittance of about 0.2% in a dark state (i.e., the panel displays a dark image when applied with voltage) and a transmittance of about 30% in an illumination state (i.e., the panel displays a bright image when applied with voltage); while the IPS display panel in the present embodiment has a transmittance of about 0.02% in the dark state and a transmittance of about 30% in the illumination state. According to the comparison results, by additionally providing the optical compensation film 4, in condition of ensuring the transmittance under the illumination state, a transmittance of the IPS display panel under the dark state in the present embodiment is considerably lower than that of the existing IPS display panel, and approaching zero. In other words, the IPS display panel in the present embodiment barely involves light leakage in the dark state, and hence effectively solves the light leakage issues under the dark state.

By providing an optical compensation film on a side of the opposite substrate adjacent to the liquid crystal layer, the display panel of the present embodiment achieves an effect of compensating for the phase retardation subjected by the light passing through the liquid crystal layer, thereby offsetting the overall phase retardation of the light and considerably reducing the amount of light leakage, especially almost eliminating the light leakage under the dark state, which considerably improves the contrast ratio of the display panel and the display effect of images.

### The Second Embodiment

The present embodiment provides a display panel having a structure similar with that of the first embodiment. The present embodiment differs from the first embodiment in that: the optical compensation film is located at a side of the array substrate adjacent to the liquid crystal layer.

FIG. 8 is a structural schematic view of a LCD panel in the present embodiment. As illustrated in FIG. 8, the display panel includes an array substrate 1, an opposite substrate 3 and a liquid crystal layer 2 located between the array substrate 1 and the opposite substrate 3; and a side of the array substrate 1 adjacent to the liquid crystal layer 2 is provided with an optical compensation film 4. The display panel further includes a lower polarizer 5 located at an external side of the array substrate 1 and an upper polarizer 6 located at an external side of the opposite substrate 3.

Other structures and optical conditions of various layers in the display panel of the present embodiment are similar with those in the first embodiment, without repeating herein.

The display panel of the present embodiment can bring about similar technical effects with that in the first embodiment, i.e., offsetting the overall phase retardation of the light and considerably reducing the amount of light leakage, especially almost eliminating the light leakage under the dark state, thereby considerably improving the contrast ratio of the display panel and the display effect of images.

### The Third Embodiment

The present embodiment provides a display device including any one of the display panel as disclosed in the first and second embodiments. The display device may be any product or component having display functions, such as, an electronic paper, a cell phone, a tablet computer, a television set, a display, a notebook computer, a digital photo frame and a navigator.

The display device of the present embodiment includes any one of the display panel as disclosed in the first and second embodiments, and can offset the overall phase retardation of the light and considerably reduce the amount of light leakage, especially almost eliminate the light leakage under the dark state, and thereby considerably improves the contrast ratio of the display panel and the display effect of images.

It should be understood that, foregoing specific implementations are merely illustrative embodiments for describing the principles of the present disclosure. However, the present disclosure is not intended to be limited thereto. For those skilled in the art, various modifications and improvements may be made without departing from the scope and spirit of the present disclosure, and those modifications and improvements shall also be regarded as fallen within the scope of protection of the present disclosure.

1. A display panel, comprising: an array substrate, an opposite substrate, a liquid crystal layer between the array substrate and the opposite substrate, and
an optical compensation film, disposed at a side of the liquid crystal layer, wherein the optical compensation film is configured to compensate for a phase retardation subjected by light passing through the liquid crystal layer.

2. The display panel according to claim 1, wherein a phase retardation caused by the optical compensation film to the light is equal to a phase retardation caused by liquid crystals in the liquid crystal layer to the light.

3. The display panel according to claim 2, wherein the optical compensation film is a first optical compensation film which satisfies an optical conditional expression nₓ>n_{y}=n_{z}, wherein nₓ indicates a refractivity in a X-axis direction of a surface of the optical compensation film, n_{y} indicates a refractivity in a Y-axis direction of a surface of the optical compensation film, and n_{z} indicates a refractivity in a Z-axis direction along a thickness of the optical compensation film; and wherein a direction of optical axis of the first optical compensation film is perpendicular to a long axis of a liquid crystal in the liquid crystal layer.

4. The display panel according to claim 2, wherein the optical compensation film is a second optical compensation film which satisfies an optical conditional expression nₓ<n_{y}=n_{z}, wherein nₓ indicates a refractivity in a X-axis direction of a surface of the optical compensation film, n_{y} indicates a refractivity in a Y-axis direction of a surface of the optical compensation film, and n_{z} indicates a refractivity in a Z-axis direction along a thickness of the optical compensation film; and wherein a direction of optical axis of the second optical compensation film is parallel to a long axis of a liquid crystal in the liquid crystal layer.

5. The display panel according to claim 3, wherein the optical compensation film further satisfies optical conditional expressions of 1.4≤nₓ≤2.0, 1.4≤n_{y}≤2.0, 1.4≤n_{z}≤2.0, and a result of (nₓ−n_{y})*d equals to the phase retardation caused by the liquids crystals in the liquid crystal layer to the light, wherein d is a thickness of the optical compensation film.

6. The display panel according to claim 1, further comprising a first protection layer and a second protection layer which are located at two sides of the optical compensation film, respectively.

7. The display panel according to claim 1, wherein the optical compensation film is located at a side of the opposite substrate adjacent to the liquid crystal layer, or, is located at a side of the array substrate adjacent to the liquid crystal layer.

8. The display panel according to claim 1, wherein a phase retardation caused by the opposite substrate to the light is equal to a phase retardation caused by the array substrate to the light; and a direction of optical axis of the opposite substrate is orthogonal to a direction of optical axis of the array substrate.

9. The display panel according to claim 1, wherein a material of the optical compensation film comprises cellulose triacetate.

10. A display device, comprising the display panel according to claim 1.

11. The display panel according to claim 4, wherein the optical compensation film further satisfies optical conditional expressions of 1.4≤nx≤2.0, 1.4≤ny≤2.0, 1.4≤nz≤2.0, and a result of (nx−ny)*d equals to the phase retardation caused by the liquids crystals in the liquid crystal layer to the light, wherein d is a thickness of the optical compensation film.

12. A method for manufacturing a display panel, the display panel comprising an array substrate, an opposite substrate, and a liquid crystal layer between the array substrate and the opposite substrate, the method comprising:
disposing an optical compensation film at either side of the liquid crystal layer, wherein the optical compensation film is configured to compensate for a phase retardation subjected by light passing through the liquid crystal layer.

13. The method according to claim 12, wherein a phase retardation caused by the optical compensation film to the light is equal to a phase retardation caused by liquid crystals in the liquid crystal layer to the light.

14. The method according to claim 13, wherein the optical compensation film is a first optical compensation film which satisfies an optical conditional expression nx>ny=nz, wherein nx indicates a refractivity in a X-axis direction of a surface of the optical compensation film, ny indicates a refractivity in a Y-axis direction of a surface of the optical compensation film, and nz indicates a refractivity in a Z-axis direction along a thickness of the optical compensation film; and wherein a direction of optical axis of the first optical compensation film is perpendicular to a long axis of a liquid crystal in the liquid crystal layer.

15. The method according to claim 13, wherein the optical compensation film is a second optical compensation film which satisfies an optical conditional expression nx<ny=nz, wherein nx indicates a refractivity in a X-axis direction of a surface of the optical compensation film, ny indicates a refractivity in a Y-axis direction of a surface of the optical compensation film, and nz indicates a refractivity in a Z-axis direction along a thickness of the optical compensation film; and wherein a direction of optical axis of the second optical compensation film is parallel to a long axis of a liquid crystal in the liquid crystal layer.

16. The method according to claim 14, wherein the optical compensation film further satisfies optical conditional expressions of 1.4≤nx≤2.0, 1.4≤ny≤2.0, 1.4≤nz≤2.0, and a result of (nx−ny)*d equals to the phase retardation caused by the liquids crystals in the liquid crystal layer to the light, wherein d is a thickness of the optical compensation film.

17. The method according to claim 12, further comprising providing a first protection layer and a second protection layer at two sides of the optical compensation film, respectively.

18. The method according to claim 12, wherein the optical compensation film is provided at a side of the opposite substrate adjacent to the liquid crystal layer, or, provided at a side of the array substrate adjacent to the liquid crystal layer.

19. The method according to claim 12, a phase retardation caused by the opposite substrate to the light is equal to a phase retardation caused by the array substrate to the light; and a direction of optical axis of the opposite substrate is orthogonal to a direction of optical axis of the array substrate.

20. The method according to claim 12, wherein a material of the optical compensation film comprises cellulose triacetate.
